(19) United States
(12) Patent Application Publication
(10) Pub. No.: US 2018/0341856 A1
(43) Pub. Date: Nov. 29, 2018

(54) BALANCING MEMORY CONSUMPTION OF MULTIPLE GRAPHICS PROCESSING UNITS IN DEEP LEARNING

(71) Applicant: INTERNATIONAL BUSINESS MACHINES CORPORATION, Armonk, NY (US)

(72) Inventors: Kiyokuni Kawachiya, Tokyo (JP); Tung D. Le, Tokyo (JP); Yasushi Negishi, Tokyo (JP)

(21) Appl. No.: 15/808,370

(22) Filed: Nov. 9, 2017

Related U.S. Application Data
(63) Continuation of application No. 15/604,542, filed on May 24, 2017.

(51) Int. Cl. G06N 3/08; G06N 3/063; G06N 3/04

(52) U.S. Cl. CPC G06N 3/08; G06N 3/063; G06N 3/0454

(57) ABSTRACT

A deep learning system is provided for balancing memory consumption. The deep learning system includes a central processing unit (CPU). The deep learning system further includes a plurality of Graphics Processing Units (GPUs), each having a memory that includes a neural network for neural network training. The memory of a particular one of the plurality of GPUs having a smallest memory consumption includes an additional neural network for neural network validation.

### BACKGROUND

### Technical Field

The present invention relates generally to machine learning and, in particular, to balancing memory consumption of multiple Graphics Processing Units (GPUs) in deep learning.

### Description of the Related Art

Most deep learning frameworks use GPU(s) for the neural-network training. The most common method to use multiple GPUs is data-parallelization, where each GPU has the same neural network, performs training with different sets of input data, and synchronizes the calculated network parameters with other GPUs.

When multiple GPUs are used, memory consumption among GPUs is different, and the amount of input data processed together (referred to as “batch-size”) is bounded by the most memory-consuming GPU.

### SUMMARY

According to an aspect of the present invention, a deep learning system is provided for balancing memory consumption. The deep learning system includes a central processing unit (CPU). The deep learning system further includes a plurality of Graphics Processing Units (GPUs), each having a memory that includes a neural network for neural network training. The memory of a particular one of the plurality of GPUs having a smallest memory consumption includes an additional neural network for neural network validation.

According to another aspect of the present invention, a computer-implemented method is provided for balancing memory consumption in a deep learning system having a central processing unit (CPU) and a plurality of Graphics Processing Units (GPUs). The method includes storing, in a memory of each of the plurality of GPUs, a neural network for neural network training. The method further includes storing, in the memory of a particular one of the plurality of GPUs having a smallest memory consumption, an additional neural network for neural network validation.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 shows an exemplary processing system to which the present invention may be applied, in accordance with an embodiment of the present invention;

FIG. 2 shows an exemplary GPU tree to which the present invention can be applied, in accordance with an embodiment of the present invention; and

FIGS. 3-5 show an exemplary method for balancing memory consumption of multiple Graphics Processing Units (GPUs) in deep learning training, in accordance with an embodiment of the present invention.

### DETAILED DESCRIPTION

The present invention is directed to balancing memory consumption of multiple Graphics Processing Units (GPUs) in deep learning. The deep learning can involve deep neural networks, deep convolutional neural networks, recurrent neural networks, deep belief networks, and so forth. The deep learning, and hence, the present invention, can be applied to applications including, but not limited to, for example, speech recognition, speaker recognition, speech synthesis, natural language processing, pattern recognition, language modeling, computer vision, and so forth.

One advantageous result of the present invention is that the balancing of memory consumption allows for the use of larger batch sizes. These and other advantages of the present invention are readily determined by one of ordinary skill in the art given the teachings of the present invention provided herein.

In an embodiment, validation is performed in a least-memory-consuming GPU. In an embodiment, validation can be performed in a leaf GPU of a GPU tree that is used to collect/distribute parameters. However, embodiments of the present invention can also be applied to a set of GPUs that is not arranged in a tree structure. In an embodiment, memory consumption is monitored for a while and validation is performed in the GPU whose memory consumption is the smallest.

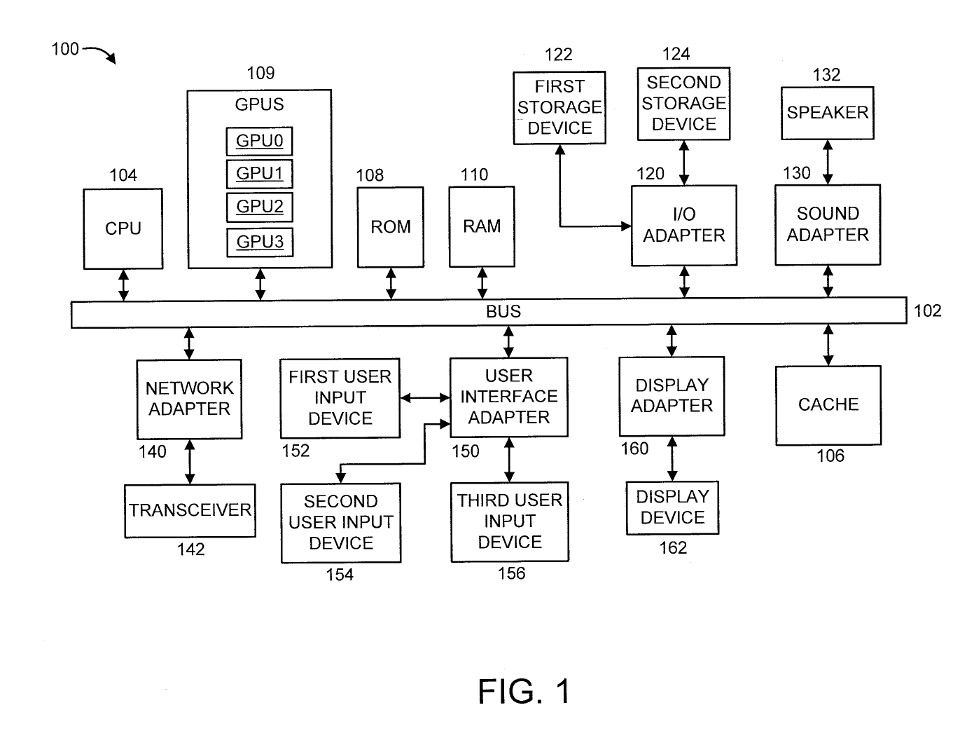

FIG. 1 shows an exemplary processing system 100 to which the invention principles may be applied, in accordance with an embodiment of the present invention. The processing system 100 includes at least one processor (CPU) 104 and a set of GPUs 109 operatively coupled to other components via a system bus 102. Each GPU includes a respective memory (RAM). A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

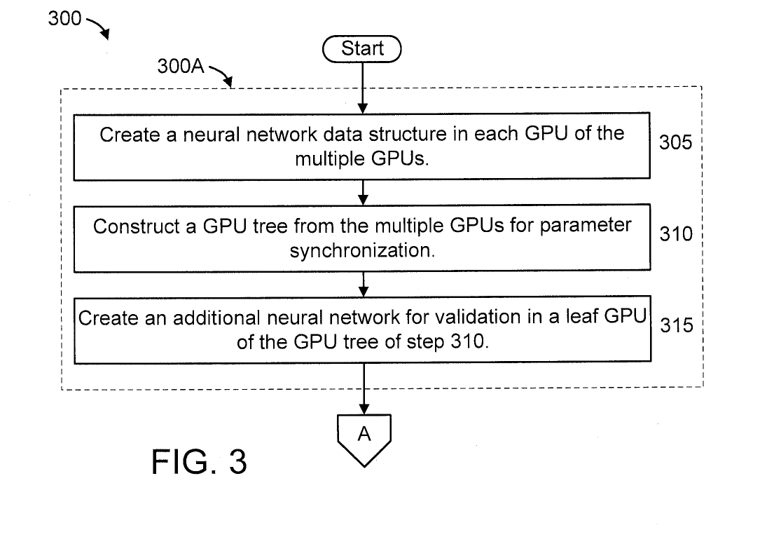

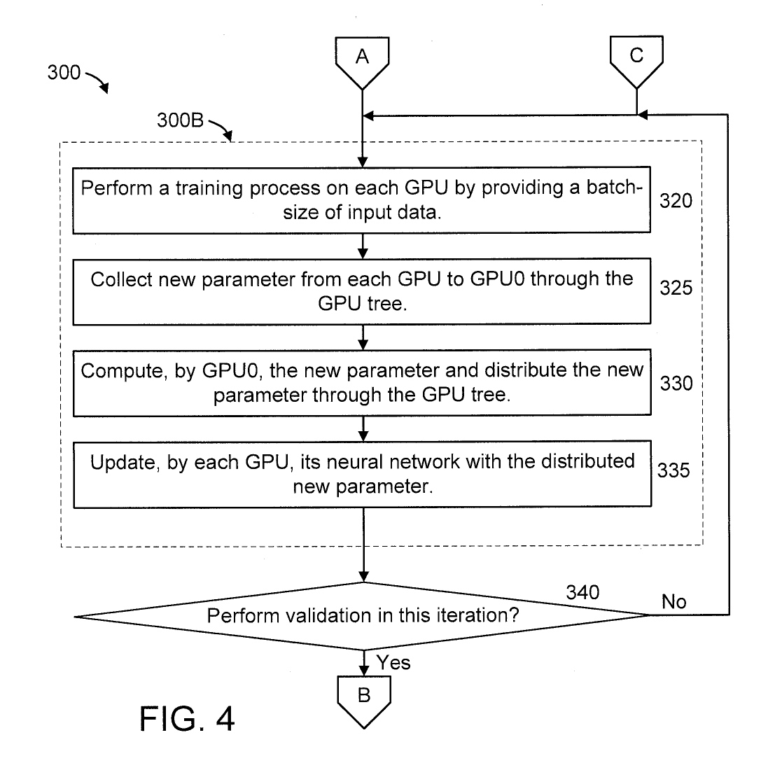

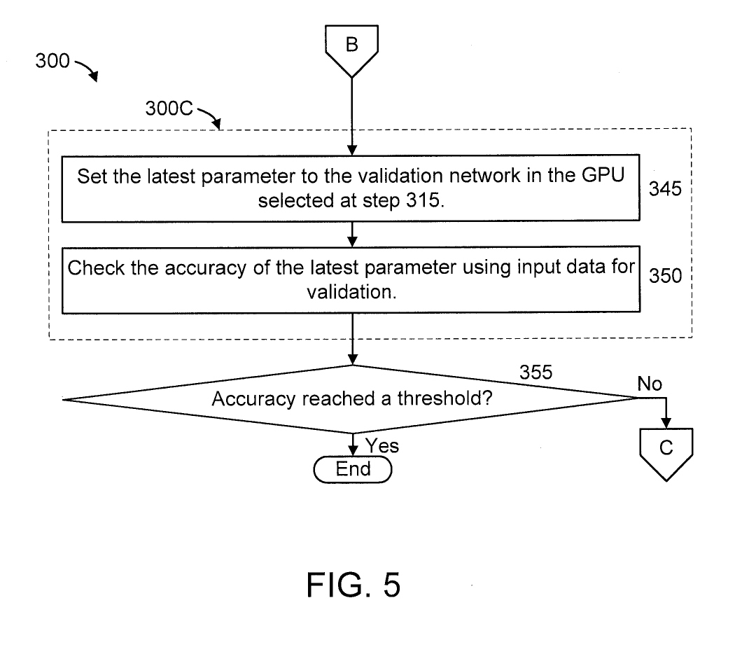

It is to be appreciated that processing system 100 may perform at least part of the method described herein including, for example, at least part of method 300 of FIGS. 3-5.

In deep learning training, “validation” is performed periodically to check the progress of learning. The validation is usually executed on 1 GPU (typically GPU0), which consumes more memory to keep an additional neural network for the validation.

Another imbalance comes from the parameter-synchronization among multiple GPUs. A typical parameter-synchronization collects a parameter from each GPU, where certain ones of the GPUs consume more memory than other ones of the GPUs.

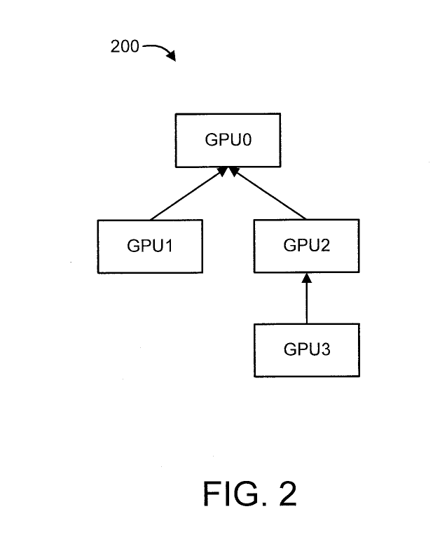

FIG. 2 shows an exemplary GPU tree 200 to which the present invention can be applied, in accordance with an embodiment of the present invention. The GPU tree 200 is a logical topology to collect/distribute parameters. In the example of FIG. 2, the GPU tree 200 includes GPU0, GPU1, GPU2, and GPU3. In order to collect/distribute data, the “root” (GPU0) and “intermediate” (GPU2) GPUs usually consume more memory than “leaf” GPUs (GPU1 and GPU3). In other embodiments, other numbers of GPUs can be used in accordance with the teachings of the present invention, while maintaining the spirit of the present invention.

In an embodiment of the present invention, validation is performed on a GPU whose memory consumption is (considered to be) the smallest. For example, in an embodiment, validation is performed on a “leaf” GPU of a GPU tree for parameter-synchronization. In the example of the GPU tree 200 shown in FIG. 2, the leaf GPU can be, for example, GPU1 or GPU3. As another example, in an embodiment, the validation-GPU is decided after doing several iterations of training and measuring the actual memory consumption of each GPU.

Hence, the present invention mitigates the situation where GPU0 consumes much more memory than other GPUs. Moreover, the present invention allows for larger batch sizes.

FIGS. 3-5 show an exemplary method 300 for balancing memory consumption of multiple Graphics Processing Units (GPUs) in deep learning training, in accordance with an embodiment of the present invention. The method 300 includes an initialization portion 300A, a training portion 300B, and a validation portion 300C. The initialization portion 300A includes steps 305, 310, and 315. The training portion 300B includes steps 320, 325, 330, and 335. The validation portion 300C includes steps 345 and 350.

At step 305, create a neural network data structure in each GPU of the multiple GPUs.

At step 310, construct a GPU tree from the multiple GPUs for parameter synchronization.

At step 315, create an additional neural network for validation in a leaf GPU of the GPU tree of step 310.

At step 320, perform a training process (e.g., a training cycle/step/iteration/etc.) on each GPU by providing a batch-size of input data.

At step 325, collect new parameter from each GPU to GPU0 through the GPU tree.

At step 330, compute, by GPU0, the new parameter and distribute the new parameter through the GPU tree.

At step 335, update, by each GPU, its neural network with the distributed new parameter.

At step 340, determine whether to perform validation in this iteration. If so, then proceed to step 345. Otherwise, return to step 320.

At step 345, set the latest parameter to the validation network in the GPU selected at step 315.

At step 350, check the accuracy of the latest parameter using input data for validation.

At step 355, determine whether the accuracy has reached a threshold accuracy. If so, then terminate the method. Otherwise, return to step 320.

In an embodiment, the GPU used for the validation as having a smallest memory consumption can be selected based on actual respective GPU memory consumptions obtained from performing multiple neural network training iterations. These and other variations of the present invention are readily determined by one of ordinary skill in the art given the teachings of the present invention provided herein, while maintaining the spirit of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A deep learning system for balancing memory consumption, comprising:
a central processing unit (CPU); and
a plurality of Graphics Processing Units (GPUs), each having a memory that includes a neural network for neural network training,
wherein the memory of a particular one of the plurality of GPUs having a smallest memory consumption includes an additional neural network for neural network validation.

2. The deep learning system of claim 1, wherein the memory of each of the plurality of GPUs includes a dedicated neural network training area for the neural network training.

3. The deep learning system of claim 1, wherein the memory of the particular one of the plurality of GPUs includes a dedicated neural network validation area for the neural network validation.

4. The deep learning system of claim 1, wherein only the memory of the particular one of the plurality of GPUs includes the additional neural network for neural network validation.

5. The deep learning system of claim 1, wherein the plurality of GPUs is arranged in a GPU tree to collect and distribute neural network parameters, and the particular one of the plurality of GPUs is selected responsive to parameters of the deep learning system being communicated using the GPU tree.

6. The deep learning system of claim 1, wherein the plurality of GPUs is arranged in a tree structure with a root GPU and at least one leaf GPU, and wherein the smallest memory consumption GPU is selected from the at least one leaf GPU.

7. The deep learning system of claim 1, wherein the smallest memory consumption is determined from actual respective GPU memory consumptions obtained from performing a plurality of neural network training iterations.

8. The deep learning system of claim 1, wherein the plurality of GPUs is arranged in a tree structure with a root GPU and at least two leaf GPUs, wherein the smallest memory consumption is determined from actual respective GPU memory consumptions obtained from performing a plurality of neural network training iterations, and wherein the actual respective GPU memory consumptions are obtained only relative to the at least two leaf GPUs.

9. The deep learning system of claim 1, wherein the plurality of GPUs are arranged in a tree structure with a root GPU and at least one leaf GPU, and wherein the root GPU is excluded from use in generating a result for the neural network validation.

10. The deep learning system of claim 1, wherein the neural network validation comprises checking an accuracy of a parameter calculated by the additional neural network for the neural network validation.
